(19) United States
(12) Patent Application Publication
(10) Pub. No.: US 2026/0275790 A1
(43) Pub. Date: Sep. 17, 2026

(54) RETRACTING DEVICE UNIT

(71) Applicant: SUGATSUNE KOGYO CO., LTD., Tokyo (JP)

(72) Inventors: Shu SHIMIZU, Tokyo (JP); Atsufumi INOUE, Tokyo (JP)

(21) Appl. No.: 19/678,155

(22) Filed: May 15, 2026

Related U.S. Application Data
(63) Continuation of application No. PCT/JP2024/041801, filed on Nov. 26, 2024.

(30) Foreign Application Priority Data
Nov. 30, 2023 (JP) 2023-202927

(51) Int. Cl. E05F 1/10

(52) U.S. Cl. CPC E05F 1/105; E05Y 2201/626; E05Y 2201/638; E05Y 2900/132

(57) ABSTRACT

A retracting device unit attached to a frame and a hinged door attached to the frame to be openable/closable and includes: a striker attached to one of the frame and the hinged door; a main body attached to the other of the frame and the hinged door; and an arm rotatably attached to the main body and configured to engage the striker to retract the hinged door toward a closing side, wherein the arm and the striker are coupled together when the hinged door is closed and separate when the hinged door is opened, and the arm includes: a spring mechanism; a conversion mechanism configured to convert a spring force of the spring mechanism into a rotational torque that rotates the arm in a direction for retracting the hinged door toward the closing side; and a damper mechanism configured to generate a damper force that opposes the rotational torque.

### CROSS-REFERENCE TO RELATED APPLICATIONS

This Application claims the benefit of priority and is a Continuation application of the prior International Patent Application No. PCT/JP2024/041801, with an international filing date of Nov. 26, 2024, which designated the United States, and is related to the Japanese Patent Application No. 2023-202927, filed Nov. 30, 2023, the entire disclosures of all applications are expressly incorporated by reference in their entirety herein.

### TECHNICAL FIELD

The present disclosure relates to a retracting device unit. Priority is claimed on Japanese Patent Application No. 2023-202927, filed Nov. 30, 2023 in Japan, the content of which is incorporated herein by reference.

### BACKGROUND OF THE INVENTION

A retracting device unit for retracting a hinged door of a building or furniture to a closed position is known (Patent Document 1 and Patent Document 2). The retracting device unit includes a retracting device attached to one of a frame and a hinged door, and a striker attached to the other of the frame and the hinged door. The retracting device has an arm that rotates to retract the striker. The arm engages the striker and retracts the striker, thereby retracting the hinged door to the closed position.

### PRIOR ART DOCUMENT

### Patent Documents

Patent Document 1: Japanese Patent No. 6732397

Patent Document 2: Japanese Patent No. 5297554

### SUMMARY OF THE INVENTION

### Problem to be Solved by the Invention

However, it is desirable for the retracting device unit to be more compact and to have higher installability.

In view of the above circumstances, an object of the present disclosure is to provide a retracting device unit that is more compact and has higher installability.

### Means for Solving the Problems

To solve the above problem, the present disclosure proposes the following means. A retracting device unit according to a first aspect of the present disclosure is a retracting device unit attached to a frame and a hinged door that is attached to the frame so as to be openable and closable, the retracting device unit including: a striker attached to one of the frame and the hinged door; a main body attached to the other of the frame and the hinged door; and an arm rotatably attached to the main body and configured to engage the striker to retract the hinged door toward a closing side, wherein the arm and the striker are coupled together when the hinged door is closed and separate from each other when the hinged door is opened, and the arm includes: a spring mechanism; a conversion mechanism configured to convert a spring force of the spring mechanism into a rotational torque that rotates the arm in a direction for retracting the hinged door toward the closing side; and a damper mechanism configured to generate a damper force that opposes the rotational torque.

### Effects of the Invention

The retracting device unit of the present disclosure is more compact and has higher installability.

### BRIEF DESCRIPTION OF DRAWINGS

FIG. 1 is a perspective view showing a retracting device unit according to the first embodiment.

FIG. 2 is an exploded view of a retracting device of the retracting device unit.

FIG. 3 is a perspective view of a striker of the retracting device unit.

FIG. 4 is a perspective view showing the retracting device unit attached to a left-hinged door.

FIG. 5 is a perspective view showing an operation of retracting the hinged door to a closed position by the retracting device.

FIG. 6 is a perspective view showing an operation of retracting the hinged door to the closed position by the retracting device.

FIG. 7 is a perspective view showing an operation of retracting the hinged door to the closed position by the retracting device.

FIG. 8 is a perspective view showing an operation of retracting the hinged door to the closed position by the retracting device.

FIG. 9 is a cross-sectional view of an arm of the retracting device corresponding to FIG. 5.

FIG. 10 is a cross-sectional view of the arm corresponding to FIG. 6.

FIG. 11 is a cross-sectional view of the arm corresponding to FIG. 7.

FIG. 12 is a cross-sectional view of the arm corresponding to FIG. 8.

FIG. 13 is a graph showing a relationship between an arm angle and a rotational torque.

FIG. 14 is a cross-sectional view of the arm when the hinged door in the closed position is moved toward an opening side.

FIG. 15 is a perspective view showing a different attachment mode of the retracting device unit.

FIG. 16 is a diagram showing a modified example of a conversion mechanism of the retracting device.

FIG. 17 is a diagram showing the modified example of the conversion mechanism.

FIG. 18 is a diagram showing the modified example of the conversion mechanism.

FIG. 19 is a diagram showing a modified example of the retracting device unit.

FIG. 20 is a diagram showing the modified example of the retracting device unit.

FIG. 21 is a diagram showing the modified example of the retracting device unit.

FIG. 22 is a diagram showing the modified example of the retracting device unit.

FIG. 23 is a diagram showing the modified example of the retracting device unit.

### DETAILED DESCRIPTION OF THE INVENTION

### First Embodiment

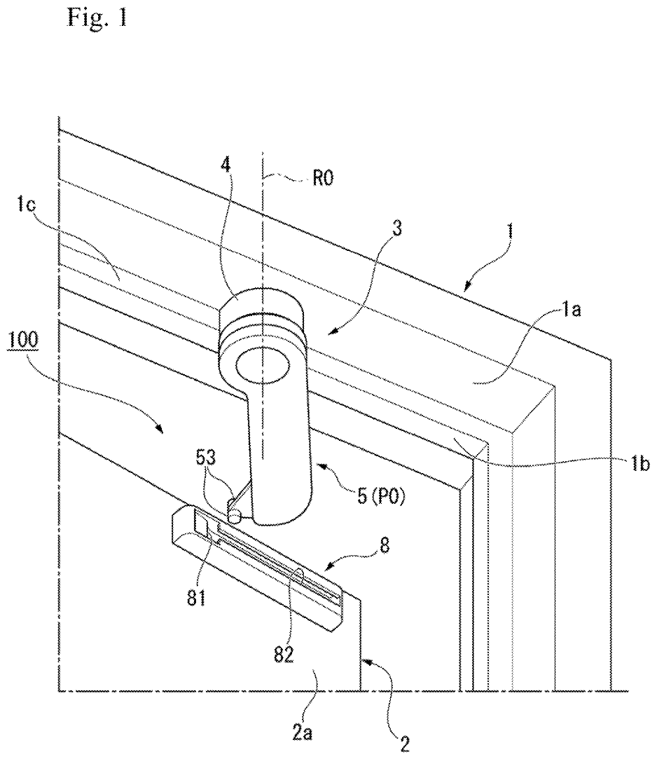

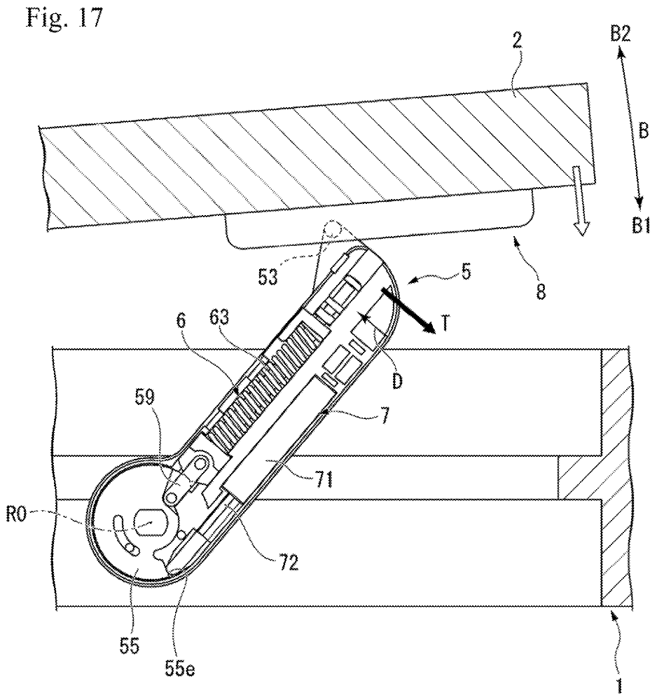

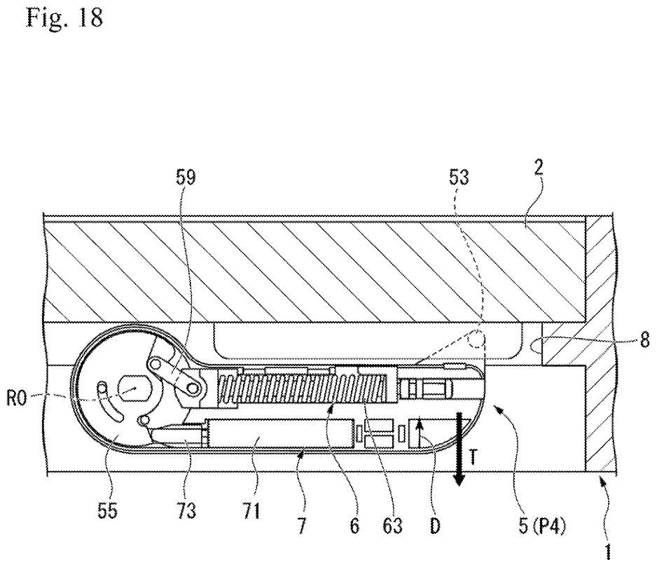

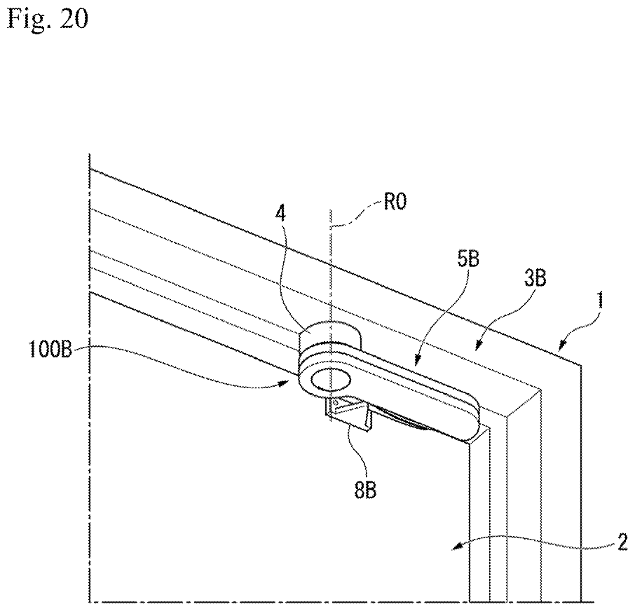

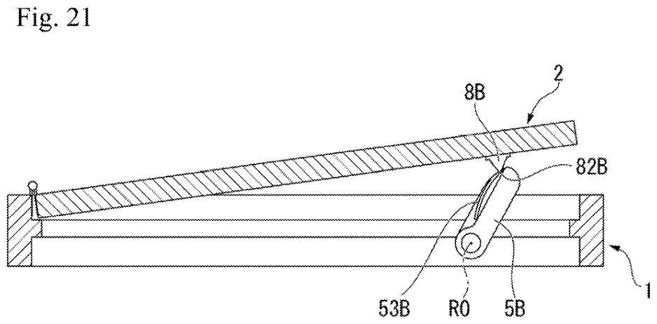

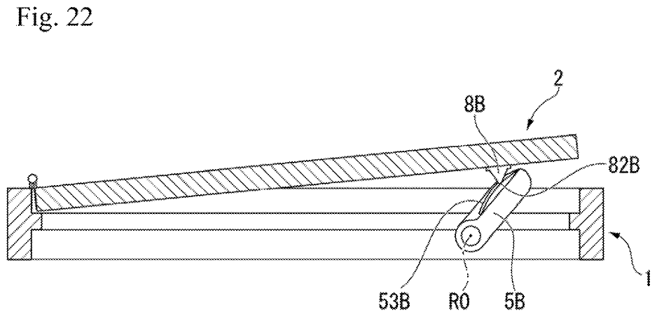

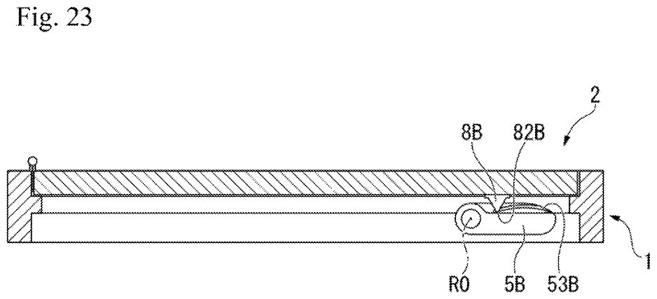

A retracting device unit (retraction device unit) 100 according to the first embodiment of the present disclosure will be explained with reference to FIG. 1 to FIG. 23.

FIG. 1 is a perspective view showing the retracting device unit 100.

The retracting device unit 100 includes a retracting device 3 attached to a frame 1, and a striker 8 attached to a hinged door 2. The hinged door 2 is a right-hinged door that is attached to the frame 1 so as to be openable and closable. The retracting device unit 100 is attached to a leading-edge side of the hinged door 2. The retracting device unit 100 has a retracting function and a damper function, and reliably retracts the hinged door 2 to the closed position while cushioning the impact when the hinged door 2 is closed.

In the following explanation, a closing direction in an opening/closing direction B of the hinged door 2 is referred to as “closing side B1,” and an opening direction in the opening/closing direction B of the hinged door 2 is referred to as “opening side B2.”

As shown in FIG. 1, the retracting device 3 is attached to a lower surface of an upper frame 1a of the frame 1. The retracting device 3 includes a main body 4 attached to the frame 1, and an arm 5 rotatably attached to the main body 4.

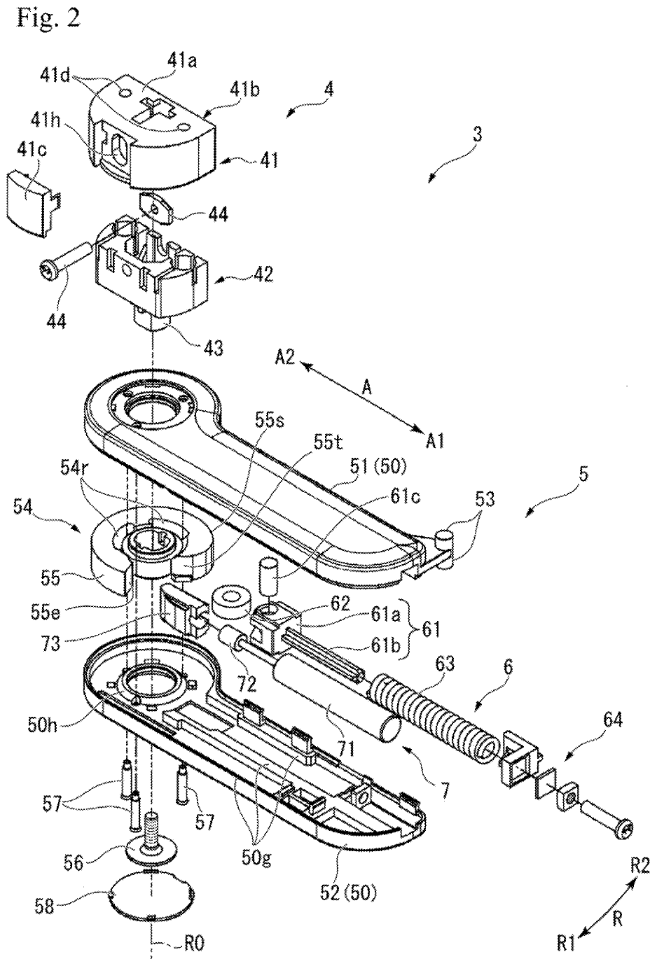

FIG. 2 is an exploded view of the retracting device 3. The main body 4 is attached to a lower surface of the upper frame 1a of the frame 1, and rotatably supports the arm 5. The main body 4 includes an upper case 41, a lower case 42, a support column 43 and a vertical adjustment mechanism 44.

The upper case 41 has an outer shape formed in a semi-cylindrical shape. A through-hole 41d through which a fastening member such as a screw passes is formed in an upper surface 41a of the upper case 41. The upper case 41 is attached to the frame 1 by a fastening member such as a screw. The upper case 41 is attached to the frame 1 in a state that the upper surface 41a of the upper case 41 is in contact with the lower surface of the upper frame 1a of the frame 1 and a flat side surface 41b of the upper case 41 is in contact with a side surface 1c of a door stop 1b of the frame 1 on the closing side B1.

The upper case 41 has an opening 41h for adjusting the vertical adjustment mechanism 44, and a cover 41c that closes the opening 41h. The cover 41c is detachably attached to the upper case 41.

The lower case 42 is a case attached to the upper case 41 from below the upper case 41. A support column 43 is provided on the lower surface of the lower case 42.

The support column 43 is a substantially cylindrical member provided on the lower surface of the lower case 42 and extending downward. The support column 43 is formed in a non-circular shape obtained by cutting out a part of a circle in a cross-section perpendicular to the vertical direction. The arm 5 is rotatably attached to the support column 43 with a central axis of the support column 43 extending in the vertical direction as a rotation axis RO.

The vertical adjustment mechanism 44 is a member that connects the upper case 41 and the lower case 42, and is a fastening member such as a screw. The vertical adjustment mechanism 44 can adjust the vertical position of the lower case 42 relative to the upper case 41. Specifically, a user releases the fastening of the upper case 41 and the lower case 42 by the vertical adjustment mechanism 44, and changes the vertical position of the lower case 42 relative to the upper case 41. After that, the user fastens the upper case 41 and the lower case 42 again to fix the vertical position of the lower case 42 relative to the upper case 41.

After attaching the main body 4 to the frame 1, the user can remove the cover 41c and adjust the vertical adjustment mechanism 44 via the opening 41h to adjust the vertical position of the lower case 42 relative to the upper case 41. This allows the user to adjust the vertical position of the arm 5 to match the position of the striker 8.

The arm 5 is rotatably attached to the main body 4 with the rotation axis RO as the center of rotation. The arm 5 includes a case 50, an engagement shaft 53, a mounting portion 54, a first fastening member 56, second fastening members 57, a lid 58, a spring mechanism 6 and a damper mechanism 7.

The case 50 is formed in a box shape extending in a longitudinal direction A perpendicular to the rotation axis RO of the arm 5 extending in the vertical direction. The case 50 includes a first case 51 and a second case 52. The first case 51 and the second case 52 face each other in the vertical direction and are connected together. The mounting portion 54, the spring mechanism 6 and the damper mechanism 7 are housed inside the case 50.

In the following explanation, the side toward the rotation axis RO in the longitudinal direction A of the arm 5 is referred to as “base end side A2”, and the side opposite to the rotation axis RO side in the longitudinal direction A of the arm 5 is referred to as “distal end side A1.” Furthermore, in a rotational direction R of the arm 5 centered on the rotation axis RO, the direction in which the arm 5 rotates when the hinged door 2 is closed is referred to as “closing side R1,” and the direction in which the arm 5 rotates when the hinged door 2 is opened is referred to as “opening side R2.”

Guide walls 50g that guide the linear motion of the spring mechanism 6 and the damper mechanism 7 along the longitudinal direction A of the case 50 are formed in the case 50 (the first case 51 and the second case 52).

A guide wall 50h that guides the rotational motion of the mounting portion 54 centered on the rotation axis RO is formed in the case 50 (the first case 51 and the second case 52).

The engagement shaft (engagement portion) 53 is a convex member provided on the distal end side A1 of the case 50. The engagement shaft 53 is formed in a shape capable of engaging with an engagement groove 82. Specifically, the engagement shaft 53 is formed in a cylindrical shape extending from the case 50 to both sides in the vertical direction (upward and downward).

The mounting portion 54 is a substantially annular member provided on the base end side A2 of the case 50. The mounting portion 54 is attached to the support column 43 with the central axis in the axial direction of the mounting portion 54 aligned with the central axis in the vertical direction of the support column 43. The mounting portion 54 is attached to the support column 43 of the main body 4 by the first fastening member 56. The non-circular support column 43 fits into a hole of the same shape provided in the mounting portion 54. Thus, the mounting portion 54 is attached to the support column 43 of the main body 4 in a non-rotatable manner. Through-holes 54r are formed in the mounting portion 54, which penetrate in the axial direction and extend along the rotational direction R. A cam 55 is formed on an outer peripheral portion of the mounting portion 54.

The cam 55 is formed on the outer peripheral portion of the mounting portion 54 and is non-rotatable relative to the support column 43 of the main body 4. The outer peripheral surface of the cam 55 includes a first outer peripheral surface 55s, a second outer peripheral surface 55t and an engagement surface 55e. The first outer peripheral surface 55s, the second outer peripheral surface 55t and the engagement surface 55e are arranged in the rotational direction R from the opening side R2 toward the closing side R1. The first outer peripheral surface 55s and the second outer peripheral surface 55t are continuous outer peripheral surfaces.

The first outer peripheral surface 55s has a constant outer diameter (cam diameter) from the rotation axis RO and has the same curvature. The first outer peripheral surface 55s is a surface on which a roller 62 of the spring mechanism 6 slides.

The outer diameter (cam diameter) of the second outer peripheral surface 55t from the rotation axis RO decreases along the rotational direction R. Specifically, the cam diameter of the second outer peripheral surface 55t decreases from the opening side R2 toward the closing side R1 along the rotational direction R. The second outer peripheral surface 55t is a surface on which the roller 62 of the spring mechanism 6 slides.

The engagement surface 55e is a flat surface extending in the radial direction. The normal to the engagement surface 55e faces the opening side R2. The engagement surface 55e is a surface that a slider 73 of the damper mechanism 7 contacts.

The second fastening members 57 fix the first case 51 and the second case 52 together. The second fastening members 57 are inserted through a space such as the through-holes 54r, and the first case 51 and the second case 52 are rotatably attached to the mounting portion 54 about the rotation axis RO.

The lid 58 is a portion of the case 50 where the first fastening member 56 and the second fastening members 57 are attached, and is a member that covers the portion on the side opposite to the main body 4. The lid 58 is detachably attached to the case 50.

The spring mechanism 6 is guided by the guide walls 50g of the case 50 and is housed in the case 50 so as to be extensible and retractable along the longitudinal direction A of the case 50. A central axis of the spring mechanism 6 in the direction of extension and contraction passes through the rotation axis RO or passes near the rotation axis RO. The spring mechanism 6 has a slider 61, a roller 62, a coil spring 63 and a fixing portion 64.

The slider 61 includes a U-shaped support portion 61a that rotatably supports the roller 62 via a shaft 61c extending in the vertical direction, and an elongated portion 61b extending from the support portion 61a toward the distal end side A1 in the longitudinal direction A. The elongated portion 61b is inserted inside the coil spring 63.

The roller 62 is rotatably attached to the shaft 61c. The outer peripheral surface of the roller 62 slides along the outer peripheral surface of the cam 55 (the first outer peripheral surface 55s and the second outer peripheral surface 55t).

The coil spring 63 is housed in the case 50 so as to be extensible and retractable along the longitudinal direction A of the case 50. The coil spring 63 is a compression spring that applies a biasing force in the extending direction in the longitudinal direction A. An end of the coil spring 63 on the distal end side A1 is in contact with the fixing portion 64. An end of the coil spring 63 on the base end side A2 is in contact with the support portion 61a of the slider 61.

The fixing portion 64 fixes the end of the coil spring 63 on the distal end side A1 to the case 50. Namely, the end of the coil spring 63 on the distal end side A1 is a fixed end, and the end of the coil spring 63 on the base end side A2 is a free end.

The damper mechanism 7 is a telescoping damper. The damper mechanism 7 is guided by the guide walls 50g of the case 50 and is housed in the case 50 so as to be extensible and retractable along the longitudinal direction A of the case 50. The damper mechanism 7 includes a cylinder 71, a rod 72 and a slider 73.

The cylinder 71 is a cylindrical member filled with a viscous fluid. The rod 72 is partially inserted into the cylinder 71, and strokes along the longitudinal direction A relative to the cylinder 71. A coil spring (not illustrated) is built into the interior of the cylinder 71, and constantly biases the rod 72 in the direction of projecting from the cylinder 71.

The slider 73 is attached to the rod 72 and moves linearly along the longitudinal direction A together with the rod 72. The slider 73 engages with the engagement surface 55e of the cam 55.

The damper mechanism 7 is housed in the case 50 in parallel with the spring mechanism 6. Namely, the direction of extension and contraction of the spring mechanism 6 (direction of the spring force) and the direction of extension and contraction of the damper mechanism 7 (direction of the damper force) substantially coincide with each other.

In the retracting device 3, the spring mechanism 6 and the damper mechanism 7, which are the main mechanisms, are integrated in the arm 5 rather than in the main body 4. Furthermore, the spring mechanism 6 and the damper mechanism 7 are housed in parallel in the case 50. Therefore, the retracting device 3 can be made compact.

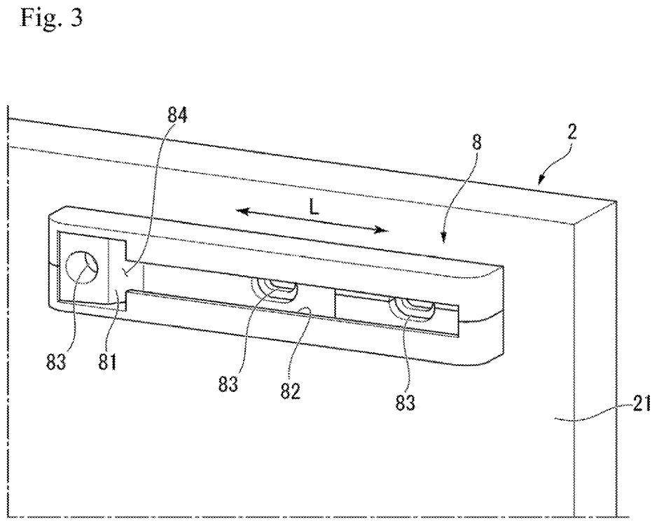

FIG. 3 is a perspective view of the striker 8.

The striker 8 is attached to a side surface 2a of the hinged door 2. The striker 8 is attached to the leading-edge side and the upper portion of the side surface 2a of the hinged door 2. The striker 8 is formed in a substantially rectangular parallelepiped shape extending in a longitudinal direction L. The striker 8 includes a bumper 81 and an engagement groove 82.

A through-hole 83 through which a fastening member such as a screw passes is formed in the striker 8. The striker 8 is attached to the side surface 2a of the hinged door 2 by a fastening member such as a screw.

The bumper 81 is a curved surface that the engagement shaft 53 of the arm 5 first contacts when it contacts the striker 8. The bumper 81 is formed in a slope shape recessed relative to the side surface 2a.

The engagement groove (engagement portion) 82 is a groove that engages with the engagement shaft 53 of the arm 5, and extends from the bumper 81 in the longitudinal direction L. The engagement shaft 53 of the arm 5 is inserted inside the engagement groove 82 from an insertion opening 84 formed near the bumper 81, and moves toward the leading-edge side while engaging with the engagement groove 82.

At least a part of the through-hole 83 is formed inside the engagement groove 82. Therefore, even without providing a cover on the through-hole 83, the through-hole 83 is difficult to see from the outside.

In the present embodiment, the striker 8 is attached to the side surface 2a of the hinged door 2 with the longitudinal direction L of the striker 8 aligned with the width direction of the hinged door 2, and with the bumper 81 facing the hinged side.

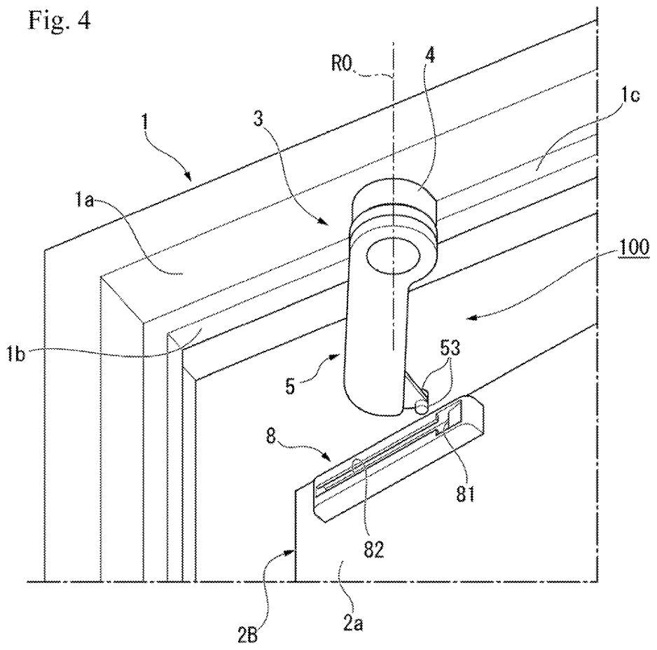

FIG. 4 is a perspective view showing the retracting device unit 100 attached to a left-hinged door 2B. The outer shapes of the case 50 and the engagement shaft 53 of the arm 5 are formed in a shape that is plane-symmetric with respect to a horizontal plane perpendicular to the vertical direction. Therefore, as shown in FIG. 4, by attaching the arm 5 to the main body 4 with the vertical direction reversed, the retracting device unit 100 can be attached to the left-hinged door 2B.

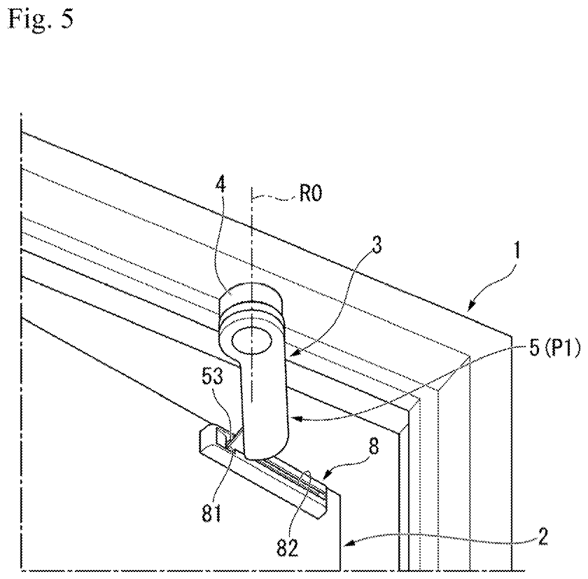

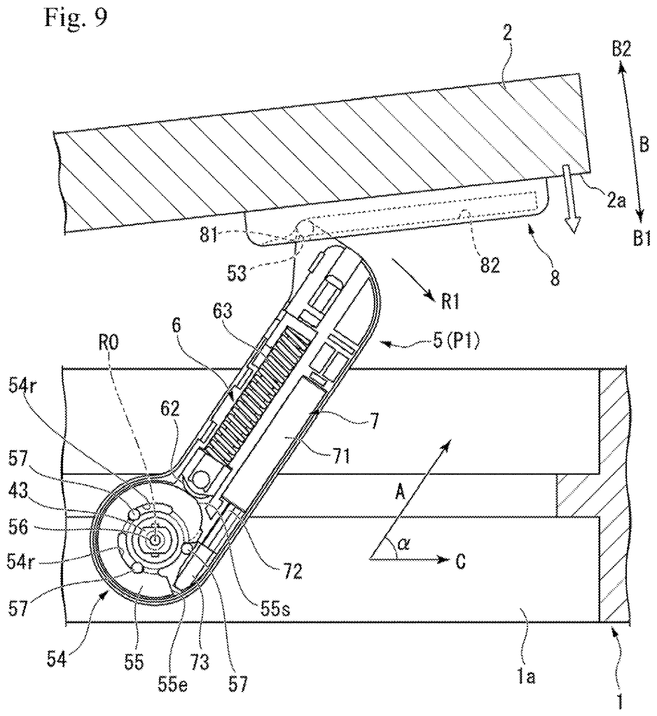

Next, the operation of the retracting device unit 100 will be explained. FIG. 5 to FIG. 8 are perspective views showing the operation of retracting the hinged door 2 to the closed position by the retracting device unit 100. FIG. 9 to FIG. 12 are cross-sectional views of the arm 5 corresponding to FIG. 5 to FIG. 8. The arm 5 and the striker 8 are coupled together when the hinged door 2 is closed, and separate from each other when the hinged door 2 is opened.

In the following explanation, the angle formed by the direction C in which the upper frame 1a of the frame 1 extends and the longitudinal direction A of the arm 5 is referred to as “arm angle α.”

As shown in FIG. 1, before the retracting device 3 performs the retracting operation on the hinged door 2, the arm 5 is not engaged with the striker 8 and is arranged at a standby position P0. No rotational torque T that rotates the arm 5 toward the closing side R1 is generated in the arm 5 arranged at the standby position P0.

As shown in FIG. 5 and FIG. 9, when the hinged door 2 is closed, the engagement shaft 53 of the arm 5 contacts the bumper 81 of the striker 8. The arm 5 moves to the first position P1. When the arm 5 is arranged at the first position P1, the roller 62 of the spring mechanism 6 is in contact with the first outer peripheral surface 55s of the cam 55. Therefore, no rotational torque T that rotates the arm 5 toward the closing side R1 is generated in the arm 5 arranged at the first position P1. In addition, when the arm 5 is arranged at the first position P1, the slider 73 of the damper mechanism 7 is not in contact with the engagement surface 55e of the cam 55. Therefore, the damper mechanism 7 has not stroked in the contracting direction and no damper force D is generated.

The bumper 81 is formed in a slope shape recessed relative to the side surface 2a. Therefore, the bumper 81 can cushion the impact when the engagement shaft 53 of the arm 5 strikes the bumper 81 of the striker 8, thereby reducing contact noise.

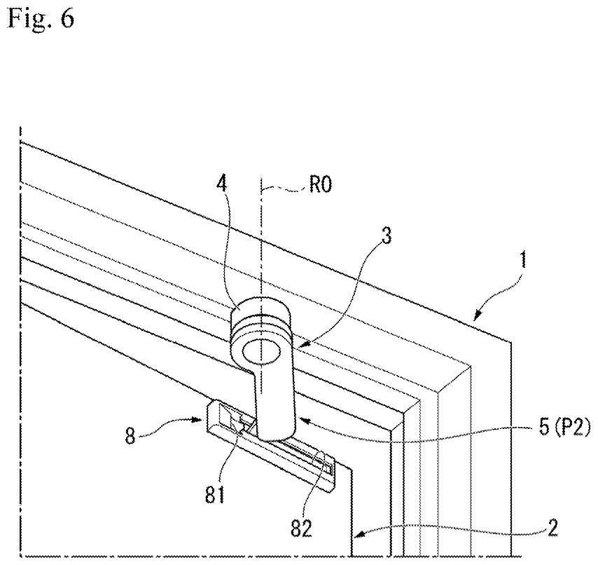

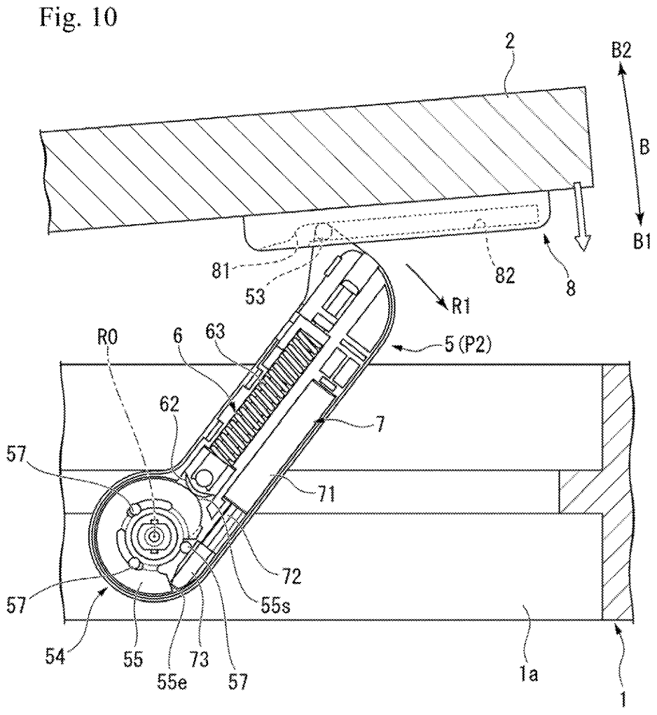

As shown in FIG. 6 and FIG. 10, when the hinged door 2 is further closed, the engagement shaft 53 of the arm 5 enters the internal space from the insertion opening 84 along the bumper 81 of the striker 8. The arm 5 moves to the second position P2. When the arm 5 is arranged at the second position P2, the roller 62 of the spring mechanism 6 is in contact with the first outer peripheral surface 55s of the cam 55. Therefore, no rotational torque T that rotates the arm 5 toward the closing side R1 is generated in the arm 5 arranged at the second position P2. In addition, when the arm 5 is arranged at the second position P2, the slider 73 of the damper mechanism 7 is not in contact with the engagement surface 55e of the cam 55. Therefore, the damper mechanism 7 is not stroked in the contracting direction and no damper force D is generated.

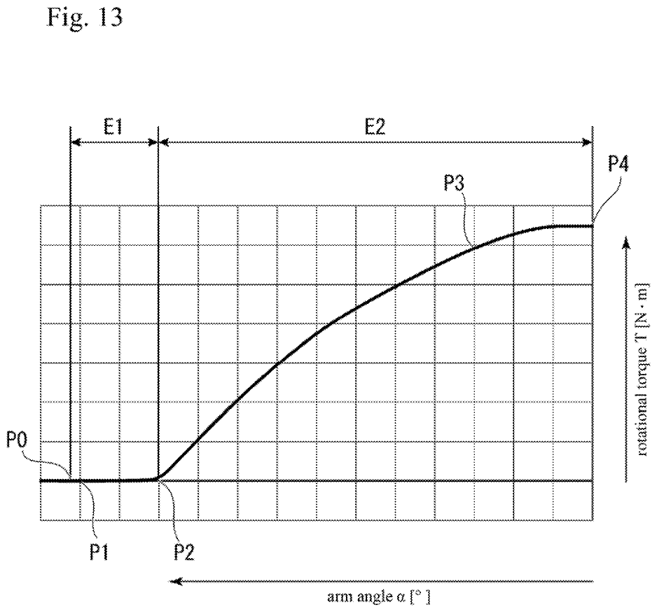

FIG. 13 is a graph showing the relationship between the arm angle α and the rotational torque T.

Until the arm 5 moves from the standby position P0 through the first position P1 to the second position P2, no rotational torque T that rotates the arm 5 toward the closing side R1 is generated in the arm 5. The range of the movement of the arm 5 from the standby position P0 to the second position P2 is referred to as a “free zone (torque non-generation zone) E1.” The difference in the arm angle α between the arm 5 arranged at the standby position P0 and the arm 5 arranged at the second position P2 is, for example, 10 to 12 degrees.

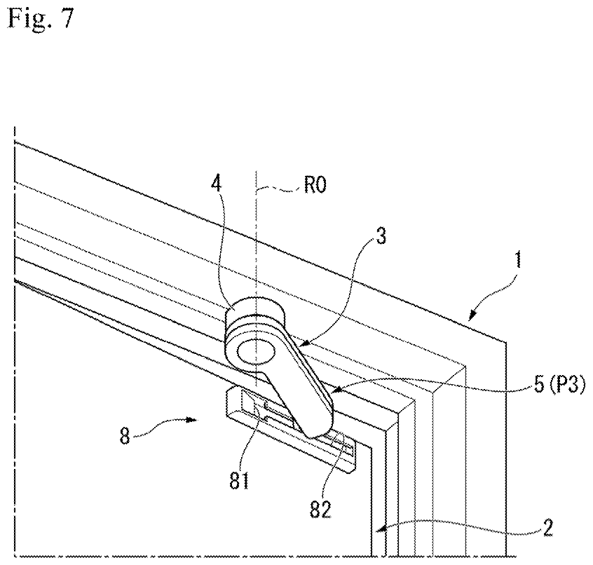

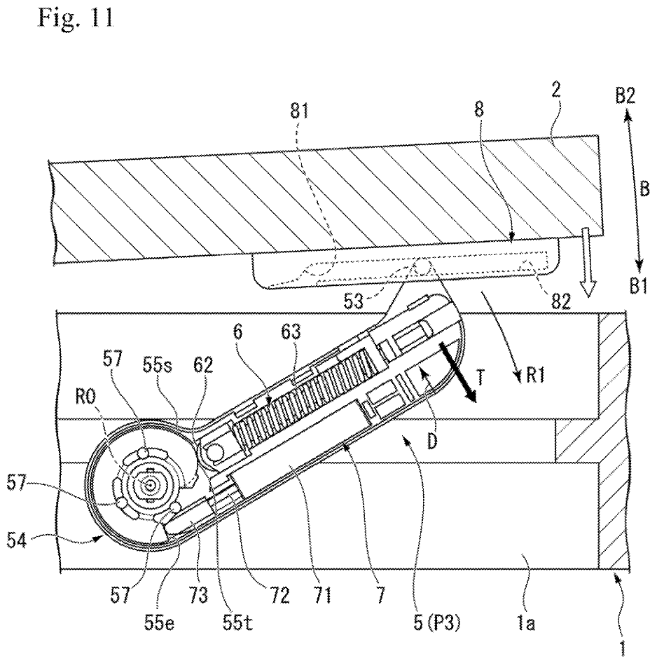

As shown in FIG. 7 and FIG. 11, when the hinged door 2 is further closed, the engagement shaft 53 of the arm 5 moves toward the leading-edge side along the engagement groove 82. The arm 5 moves beyond the free zone E1 into a retracting zone E2 (the third position P3 is a part of the retracting zone E2). When the arm 5 is arranged in the retracting zone (torque generation zone) E2, the roller 62 of the spring mechanism 6 is in contact with the second outer peripheral surface 55t of the cam 55. The second outer peripheral surface 55t is a surface on which the cam diameter decreases from the opening side R2 toward the closing side R1 along the rotational direction R. The roller 62 slides toward the closing side R1 by the extending force of the coil spring 63 of the spring mechanism 6. As a result, the rotational torque T that rotates the arm 5 toward the closing side R1 is generated in the arm 5 arranged in the retracting zone E2.

Namely, the cam 55 is a conversion mechanism that converts the spring force of the spring mechanism 6 into a rotational torque that rotates the arm 5 toward the closing side R1 (the direction in which the hinged door 2 is retracted toward the closing side B1). In the present embodiment, a torque generation mechanism (the spring mechanism 6 and the conversion mechanism) that generates the rotational torque T is housed in the arm 5.

In addition, when the arm 5 is arranged in the retracting zone E2, the slider 73 of the damper mechanism 7 is in contact with the engagement surface 55e of the cam 55. The damper mechanism 7 is stroked in the contracting direction and pressed against the engagement surface 55e of the cam 55. Thus, a damper force D that opposes the rotational torque T is generated.

The arm 5 arranged in the retracting zone E2 rotates toward the closing side R1 by the rotational torque T that rotates the arm 5 toward the closing side R1. As a result, the engagement shaft 53 of the arm 5 engages with the engagement groove 82 of the striker 8, retracting the hinged door 2 toward the closing side B1. At this time, since the damper force D that opposes the rotational torque T is generated, the arm 5 slowly rotates toward the closing side R1. Therefore, the hinged door 2 is slowly closed toward the closed position.

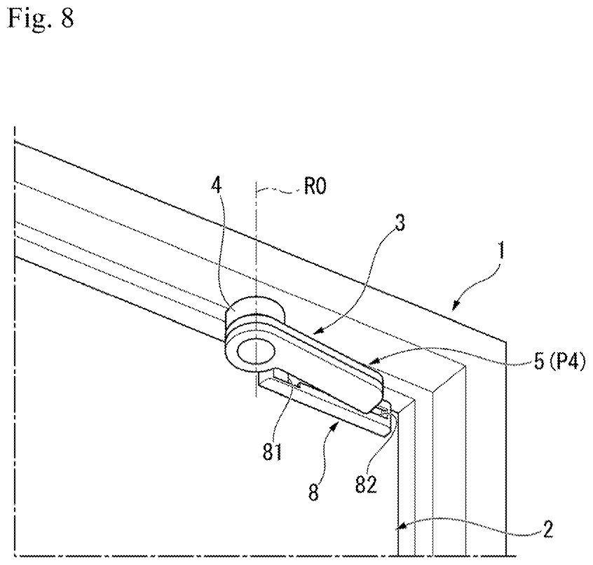

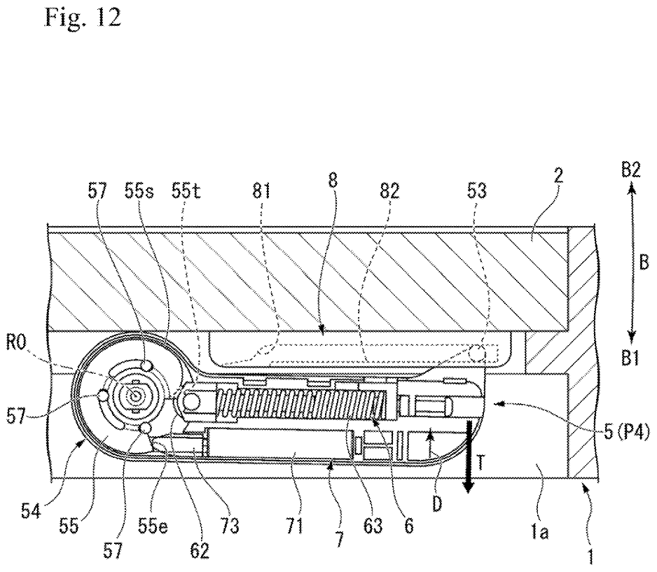

As shown in FIG. 8 and FIG. 12, the arm 5 rotates to the fourth position P4, and the hinged door 2 is reliably retracted to the closed position.

The rotation zone in which the arm 5 rotates about the rotation axis RO is divided into the free zone (torque non-generation zone) E1 and the retracting zone (torque generation zone) E2. When the arm 5 is arranged in the free zone (torque non-generation zone) E1, no rotational torque T that rotates the arm 5 toward the closing side R1 is generated. When the arm 5 is arranged in the retracting zone (torque generation zone) E2, the rotational torque T that rotates the arm 5 toward the closing side R1 is generated.

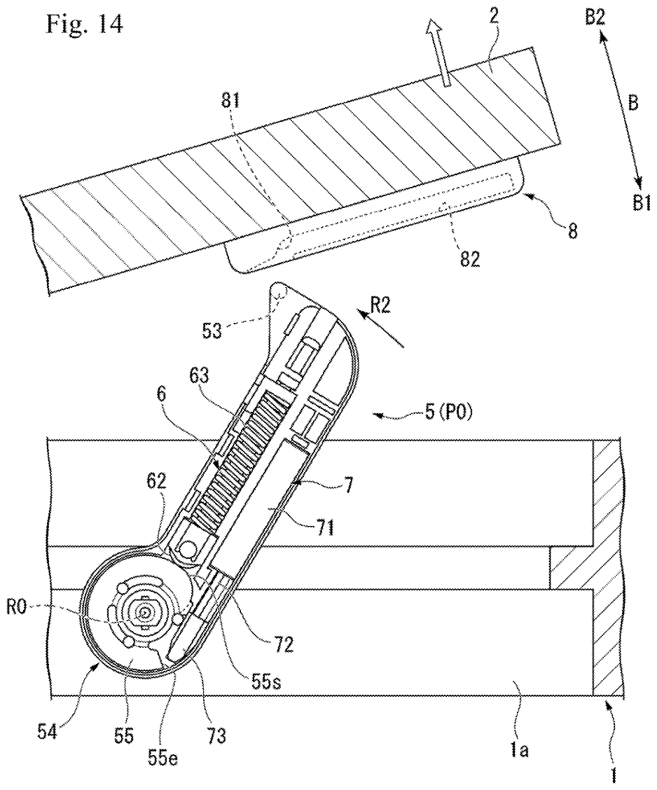

FIG. 14 is a cross-sectional view of the arm 5 when the hinged door 2 in the closed position is moved toward the opening side B2. When a user moves the hinged door 2 toward the opening side B2, the engagement shaft 53 of the arm 5 engages with the engagement groove 82 of the striker 8, and the arm 5 rotates toward the opening side R2. When the user moves the hinged door 2 further toward the opening side B2, the arm 5 separates from the bumper 81 of the striker 8. At this time, since the arm 5 is arranged in the free zone (torque non-generation zone) E1, no rotational torque T is generated. Therefore, the arm 5 is positioned at a position immediately after separating from the bumper 81. Namely, each time the hinged door 2 is opened, the arm 5 is automatically positioned at a standby position P0 where the engagement shaft 53 can suitably contact the bumper 81.

For example, even if the striker 8 is slightly offset in the width direction (left-right direction) of the hinged door 2, the arm 5 is automatically positioned at the standby position P0 each time the hinged door 2 is opened. Therefore, the main body 4 only needs to have the vertical adjustment mechanism 44 and does not need to have a horizontal adjustment mechanism.

For example, even if the position of the striker 8 in the width direction (left-right direction) shifts due to deterioration of the hinge of the hinged door 2 over time, the arm 5 is automatically positioned at the standby position P0 each time the hinged door 2 is opened.

The standby position P0 is not a fixed position but any position within the free zone E1. The standby position P0 is optimized each time the hinged door 2 is opened depending on the position of the striker 8 and the position of the hinged door 2.

According to the retracting device unit 100 of the present embodiment, the spring mechanism 6 and the damper mechanism 7, which are the main mechanisms, are integrated in the arm 5 rather than in the main body 4 in the retracting device 3. Furthermore, the spring mechanism 6 and the damper mechanism 7 are housed in parallel in the case 50. Therefore, the retracting device 3 can be made compact. Furthermore, the number of parts of the retracting device unit 100 can be reduced.

According to the retracting device unit 100 of the present embodiment, since the retracting device 3 has the vertical adjustment mechanism 44, there is no need to provide a vertical adjustment mechanism in the striker 8, and the striker 8 can be made compact.

According to the retracting device unit 100 of the present embodiment, since the free zone E1 is provided in the rotation zone of the arm 5, the arm 5 is automatically positioned at the standby position P0 each time the hinged door 2 is opened, thereby achieving high installability. The standby position P0 of the arm 5 is optimized regardless of conditions such as the position of the striker 8 or deterioration of the hinge of the hinged door 2 over time. Furthermore, since the free zone E1 is provided in the rotation zone of the arm 5, there is less rebounding when closing the hinged door 2, and the hinged door 2 can be easily closed even when closed slowly.

Although the first embodiment of the present disclosure is explained in detail with reference to the drawings, the specific configuration is not limited to the present embodiment, and design changes and the like within the scope that does not depart from the scope of the present disclosure are also included. Furthermore, the components shown in the above embodiment and in the modified examples shown below can be combined as appropriate.

### Modified Example 1

In the above embodiment, the retracting device 3 is attached to the frame 1, and the striker 8 is attached to the hinged door 2. However, the retracting device 3 may be attached to the hinged door 2, and the striker 8 may be attached to the frame 1.

### Modified Example 2

In the above embodiment, the retracting device unit 100 is attached to the leading-edge side of the hinged door 2. However, the retracting device unit 100 may be attached to the hinged side.

### Modified Example 3

In the above embodiment, the damper mechanism 7 is a linear damper. However, the damper mechanism 7 may be a rotary damper.

### Modified Example 4

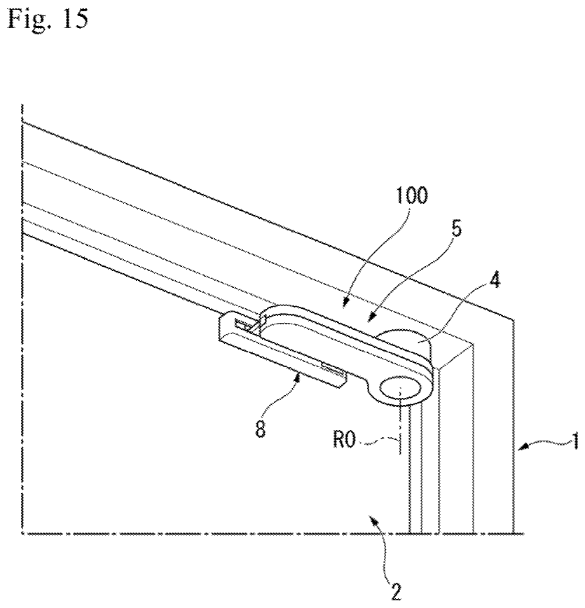

FIG. 15 is a perspective view showing a different attachment mode of the retracting device unit 100.

The retracting device unit 100 may be attached in a reversed orientation with respect to the width direction (left-right direction) of the hinged door 2.

### Modified Example 5

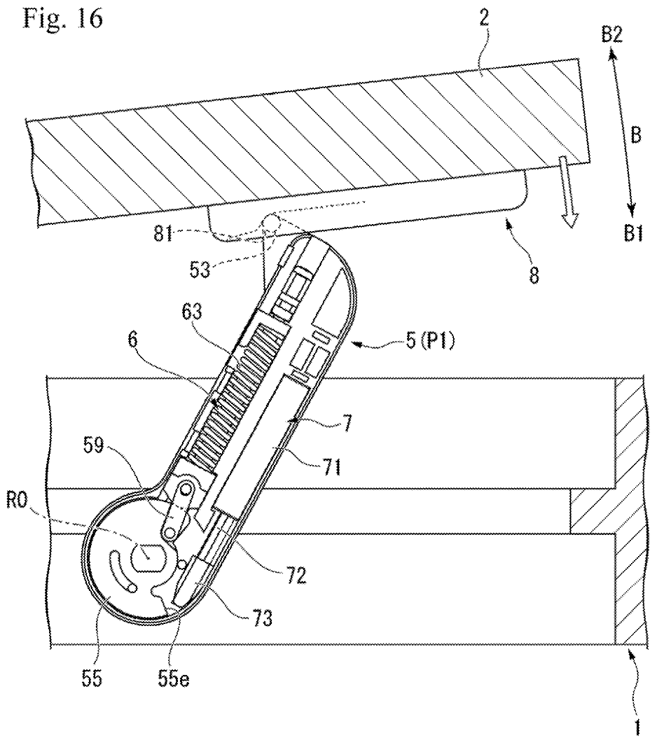

FIG. 16 to FIG. 18 are diagrams showing a modified example of the conversion mechanism.

In the above embodiment, the conversion mechanism that converts the spring force of the spring mechanism 6 into a rotational torque that rotates the arm 5 toward the closing side R1 is the cam 55. However, the aspect of the conversion mechanism is not limited to this. The conversion mechanism may include a link mechanism 59 as shown in FIG. 16 to FIG. 18. In this case, the spring mechanism 6 is connected to the cam 55 by the link mechanism 59 instead of the roller 62.

### Modified Example 6

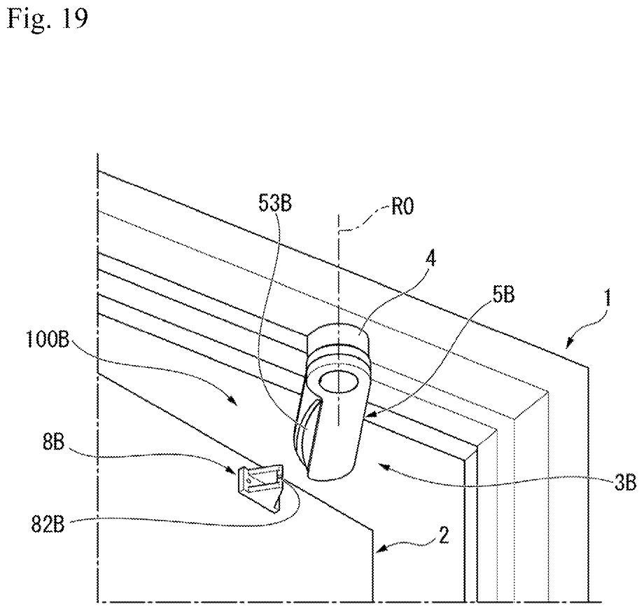

FIG. 19 to FIG. 23 are diagrams showing a retracting device unit 100B, which is a modified example of the retracting device unit 100. The retracting device unit 100B includes a retracting device 3B and a striker 8B. The retracting device 3B includes a main body 4 and an arm 5B. Compared to the arm 5, the arm 5B has an engagement groove (engagement portion) 53B instead of the engagement shaft 53. Compared to the striker 8, the striker 8B has an engagement shaft (engagement portion) 82B instead of the engagement groove 82. Namely, in the retracting device unit 100B, the arrangement of the engagement groove and the engagement shaft is reversed from that of the retracting device unit 100.

### INDUSTRIAL APPLICABILITY

The present invention can be applied to a device for retracting a hinged door and the like.

Description of the Reference Numerals
100, 100B, 100C: retracting device unit
1: frame
1a: upper frame
1c: side surface
2: hinged door (right-hinged)
2a: side surface
2B: hinged door (left-hinged)
3, 3B, 3C: retracting device
4, 4C: main body
41: upper case
41a: upper surface
41b: side surface
41c: cover
41d: hole
41h: opening
42: lower case
43: support column
44: vertical adjustment mechanism
5, 5B, 5C: arm
50: case
51: first case
52: second case
53: engagement shaft (engagement portion)
53B: engagement groove (engagement portion)
54: mounting portion
55: cam
55e: engagement surface
55s: first outer peripheral surface
55t: second outer peripheral surface
59: link mechanism
6: spring mechanism
61: slider
62: roller
64: fixing portion
7: damper mechanism
71: cylinder
72: rod
73: slider
8, 8B, 8C: striker
81: bumper
82: engagement groove (engagement portion)
82B: engagement shaft (engagement portion)
84: insertion opening
A: longitudinal direction
A1: distal end side
A2: base end side
B: opening/closing direction
B1: closing side
B2: opening side
D: damper force
E1: free zone (torque non-generation zone)
E2: retracting zone (torque generation zone)
L: longitudinal direction
P0: standby position
P1: first position
P2: second position
P3: third position
P4: fourth position
R: rotational direction
R1: closing side
R2: opening side
RO: rotation axis
T: rotational torque
A: arm angle

1. A retracting device unit attached to a frame and a hinged door that is attached to the frame so as to be openable and closable, the retracting device unit comprising:
a striker attached to one of the frame and the hinged door;
a main body attached to the other of the frame and the hinged door; and
an arm rotatably attached to the main body and configured to engage the striker to retract the hinged door toward a closing side, wherein
the arm and the striker are coupled together when the hinged door is closed and separate from each other when the hinged door is opened, and
the arm includes:
a spring mechanism;
a conversion mechanism configured to convert a spring force of the spring mechanism into a rotational torque that rotates the arm in a direction for retracting the hinged door toward the closing side; and
a damper mechanism configured to generate a damper force that opposes the rotational torque.

2. The retracting device unit according to claim 1, wherein
the arm is attachable to the main body in a reversed orientation with respect to a direction along a rotation axis of the arm.

3. The retracting device unit according to claim 2, wherein
an outer shape of the arm is formed in a shape that is plane-symmetric with respect to a plane perpendicular to the rotation axis.

4. The retracting device unit according to claim 1, wherein
the conversion mechanism includes a cam.

5. The retracting device unit according to claim 1, wherein
the spring mechanism and the damper mechanism are housed in parallel inside the arm.

6. The retracting device unit according to claim 1, wherein
the main body has a vertical adjustment mechanism configured to adjust a vertical position of the arm.
